(19) United States
(12) Patent Application Publication
(10) Pub. No.: US 2025/0336007 A1
(43) Pub. Date: Oct. 30, 2025

(54) Systems And Methods For Persons To Socially Connect At Establishments

(71) Applicant: Leslie Brooks, Dartmouth, MA (US)

(72) Inventor: Leslie Brooks, Dartmouth, MA (US)

(21) Appl. No.: 19/190,445

(22) Filed: Apr. 25, 2025

Related U.S. Application Data
(60) Provisional application No. 63/638,886, filed on Apr. 25, 2024.

(51) Int. Cl. G06Q 50/00; G06Q 10/1093; H04L 51/52

(52) U.S. Cl. CPC G06Q 50/01; G06Q 10/1093; H04L 51/52

(57) ABSTRACT

Systems and methods for connecting people via a social networking system are provided. The systems and methods relate to meeting and connecting with people in real time both on-line and in-person. The users of the network are physically present in an establishment, where they can meet-up if the people mutually agree to do so. One embodiment involves creating a location-based connection between the users using geofences. Other methods use Quick Response (QR) codes and Near-Field Communication (NFC) tags to unlock the network and facilitate the meetings. The network can be used at various establishments including, for example, restaurants, bars, nightclubs, stores, hotels, casinos, sporting events, schools, libraries, coffee shops, and the like.

### CROSS-REFERENCE TO RELATED APPLICATIONS

The application claims the benefit of U.S. Provisional Patent Application No. 63/638,886 filed Apr. 25, 2024, the entire disclosure of which is hereby incorporated by reference.

### BACKGROUND OF THE INVENTION

### Field of the Invention

The present invention relates generally to connecting people via a social networking system. More particularly, the systems and methods relate to meeting and connecting with people in real time. The meetings and connections are both on-line and in-person and can take place at a variety of establishments such as, for example, restaurants, bars, nightclubs, stores, hotels, casinos, sporting events, schools, libraries, coffee shops, and the like.

### BACKGROUND OF THE INVENTION

In recent years, more people have become interested in connecting with other people having similar interests and backgrounds using various social networking platforms. For example, users of such social networking platforms might want to connect with other users who have attended the same school or work in the same industry. Other users are interested in connecting with people who live/work in the same geographic area. Still other people want to connect with users having the same hobbies such shopping, sports, music, books, arts, and the like.

One problem, however, with conventional social networking systems is they are commonly based on computer applications, where the users connect with other users exclusively on-line. There is no real, in-person interaction between the users, unless they decide to meet at a place in the future. Such in-person meetings require lengthy and time-consuming steps such as selecting an appropriate place or venue, scheduling, transportation, safety concerns, and the like. There is a need for a new system, where users can meet and connect with other interested users both on-line and in-person and in real-time. The users should be able to introduce themselves on-line and meet immediately thereafter in-person if there is mutual interest. It would be desirable to have a system connecting people-to-people on demand and in live settings such as a restaurant, pub, nightclub, or other locale. Particularly, the system should help people who are personally shy and do not know how to approach and meet other people in a large or small venue. The system should provide a mechanism for introducing people with similar interests on-line and meeting each other in-person off-line. In this way, a person who is interested in meeting another can both chat on-line and meet with that person in the same venue if there is mutual interest.

The present invention provides such a social networking system and method. The system and method of the present invention has many advantages, features, and benefits as described further below.

### SUMMARY OF THE INVENTION

The present invention relates generally to methods and systems for connecting people via a social networking program. The connections are in real time both on-line and in-person and can take place at a variety of places such as, for example, restaurants, bars, nightclubs, stores, hotels, casinos, sporting events, schools, libraries, coffee shops, and the like.

In one embodiment, a method for socially connecting persons, comprises the steps of: a) creating a Quick Response (QR) code for a business member of a social network, wherein the business member has an establishment, the network having multiple business members, wherein each business member in the network has a different QR code than another business member; b) receiving a request from multiple persons who wish to join the social network, wherein each person scans the QR code for the same business member in the network and each person is physically present at the same establishment of the business member; c) identifying a first user of the network based on the user creating a first preference set and a first profile on a computing device; d) identifying at least a second user of the network based on the second user creating a second preference set and a second profile on a computing device; and e) matching the first user and second user based on the first and second user profiles and allowing the first and second users to chat with each other on their computing devices so that the first user can meet the second user in-person at the establishment if such a meeting is mutually-agreeable.

The first and second preference sets can include a reason for meeting people as either socializing or dating or networking or hanging out or friendship. The first and second preference sets can also include age ranges, physical features, and genders. Furthermore, the first and second profiles can include photographs and biographies of the first and second users. Different computing devices including, but not limited to mobile phones, personal computers, laptops, and hand-held tablets can be used in accordance with the invention.

In another embodiment, the socially connecting method comprises the steps of: a) creating a connection between multiple persons who wish to join a social network and a business member of the social network, wherein the business member has an establishment, the connection being made by an information exchange between the persons and business member using computing devices having Near Field Communication (NFC) tags, and each person is physically present at the establishment of the business member; b) identifying a first user of the network based on the user creating a first preference set and a first profile on a computing device; c) identifying at least a second user of the network based on the second user creating a second preference set and a second profile on a computing device; and d) matching the first user and second user based on the first and second user profiles and allowing the first and second users to chat with each other on their computing devices so that the first user can meet the second user in-person at the establishment if such a meeting is mutually-agreeable.

In yet another embodiment, the method involves creating a location-based connection between subscribers on a social network, comprising the steps of: a) creating a first geofence around a location of a first subscriber and communicating a first group of establishments of interest inside of the geofence to the first subscriber on a first computing device, wherein the first subscriber selects a specific establishment; b) creating a second geofence around a location of a second subscriber and communicating a second group of establishments of interest inside of the geofence to the second subscriber on a second computing device, wherein the second subscriber selects a specific establishment, wherein the first and second subscribers select the same specific establishment inside of the geofence; c) creating a third geofence around the specific establishment selected by the first and second subscribers on their computing devices, wherein the first and second subscribers enter the third geofence; and d) receiving requests from the first and second subscriber to connect with each other on the social network, the first and second subscribers being virtually present in the third geofence and physically present in the selected establishment.

Then, there is the step of e) identifying the first subscriber of the network based on the first subscriber creating a first preference set and a first profile on the first computing device; f) identifying the second subscriber of the network based on the second subscriber creating a second preference set and a second profile on the second computing device; and g) matching the first subscriber and second subscriber based on the first and second subscriber profiles and allowing the first and second subscribers to chat with each other on their computing devices so that the first subscriber can meet the second subscriber in-person at the establishment if such a meeting is mutually agreeable. In this version, the first and second geofences can be circular, wherein each has a specific radius.

### BRIEF DESCRIPTION OF THE DRAWINGS

The novel features that are characteristic of the present invention are set forth in the appended claims. However, the preferred embodiments of the invention, together with further objects and attendant advantages, are best understood by reference to the following detailed description in connection with the accompanying drawings in which:

FIG. 1 is a block diagram illustrating one embodiment of the present invention, wherein one step of the method involves a user follows a Global Positioning System (GPS) signal to enter an establishment and connect with other users in the same establishment;

FIG. 2 is a block diagram illustrating one embodiment of the present invention, wherein one step of the method involves a user tapping a NFC tag in an establishment and connecting with other users in the same establishment; and

FIG. 3 is a block diagram illustrating one embodiment of the present invention, wherein one step of the method involves a user scanning a QR code in an establishment and connecting with other users in the same establishment.

### DETAILED DESCRIPTION OF THE INVENTION

The present invention relates generally to systems and methods for connecting people via a social networking system. M ore particularly, the system relates to meeting and connecting with people in real time both on-line and in-person at an establishment. By the term, “establishment” as used herein, it is meant any business, institution, organization venue, event, location, point of interest, locale, and the like. For example, such establishments can include restaurants, pubs, nightclubs, stores, businesses, sporting events, theater performances, concerts, museums, libraries, art centers, and the like.

In one embodiment of the system and method of the present invention, a location tracking computer application (App) based on global positioning system (GPS) technology is first used to establish the precise location of a subscriber's device.

The system then creates a first circular geofence around the subscriber's location on the map and finds relevant points of interest for the subscriber. For example, Google® M aps or Places with Google Application Programming Interface (API), which basically allows two Apps to talk to each other, can be used for pinging points of interest. In general, Google® Maps API is used to display maps and geographic information on a website allowing users to interact with the map interface. Google® Places API is used to retrieve information about points of interest. A wide variety of points of interest can be displayed. For example, the points of interest can include restaurants, bars, pubs, nightclubs, hotels, businesses, casinos, gyms, stadiums, schools, coffee shops, and the like. The first geofence or predefined region has a radius of predetermined distance (for example, 100 meters). The subscriber can filter the different properties that are displayed based on a variety of parameters, for example, the precise distance from his/her location.

Next, the subscriber selects a specific property to visit. Once the subscriber does this and arrives at a predetermined physical distance from the selected property, the subscriber can enter the virtual geofence of that property. The geofence is a virtual perimeter or boundary that encloses the property. Once the subscriber enters through the virtual geofence, the subscriber can connect with other subscribers inside of the property's geofence. The subscribers who enter the geofence are eligible to send to and receive messages from other subscribers on their mobile devices. The Google® Maps or Places API is integrated into the App of the present invention and a subscriber's location is pinged once they enter the geofence allowing the subscriber to check-in and socially connect with other subscribers within the geofence. A key feature of the App of the present invention is that that a subscriber can only socially connect with other subscribers who are physically present in the specific property, where the geofence has been established. That is, the subscribers must be physically present in the establishment to socially connect and message each other. Thus, the system of the present invention can socially connect people on demand and in real time within an establishment. The subscribers need to be physically present in the establishment to check-in and socially connect with each other. The system is particularly helpful for socially connecting people who are personally shy and do not know how to approach and meet other people.

For example, a first subscriber can select a specific establishment to visit and then check the App to see if any other subscribers are in the establishment. The subscriber can check to see if the establishment is a good “Connect Here” social meeting place. If there are other subscribers present in the establishment, then the first subscriber might want to enter, check-in, and start connecting with the other subscribers. On the other hand, if there are no other subscribers inside of the establishment, then the first subscriber might want to leave and visit a different establishment. Additional systems and methods for checking-in and socially connecting with people in an establishment in accordance with the present invention are described further below.

### Quick Response (QR) Code

In another embodiment of the system and method of this invention, a first step involves an establishment creating a Quick Response (QR) code for their business. This method is particularly effective in cases where an establishment is not listed in Google Maps or Places, for example, a pop-up festival or event, a cruise ship, and the like. The QR code can be used to check-in and start socially connecting as described further below. QR codes are generally known today and used in various businesses for advertising, marketing, and other applications. In the present invention, the QR codes are used a component of a social meeting network system. In general, QR codes are two-dimensional types of barcodes. The QR codes are generated using an on-line QR code generator that displays on-line information to the scanner when scanned. Mobile phones and other computing devices can be used to scan/detect the QR code.

More particularly, in the present invention, each establishment that wishes to participate in the “Come Gather” (CG) social meeting network will have their own unique QR code. The individual person (user) who is interested in joining the CG network scans the QR code. The user can use any suitable computing device for scanning the QR code including a mobile phone, personal computer, hand-held tablet, laptop, and the like. The device is programmed to communicate via the network of the present invention, which is preferably a wide area and wireless network. For additional security, the establishment can ask the potential user to properly identify himself/herself. For example, the potential user may need to input an access code that is provided by the establishment. This step ensures that only properly authorized users have access to the network. This extra step of inputting an access code also prevents possible users from making a copy of the QR code and using the code when they are not physically present in the given establishment.

### Near Field Communication Tags (NFC)

In another embodiment of the method of this invention, a first step involves using Near Filed Communication (NFC) technology so that two computing devices can communicate wirelessly. NFC tags are generally known and used today for facilitating data transfer between nearby computing devices such as, for example, mobile phones, personal computers, hand-held tablets, laptops, and the like. NFC tags have become more popular with businesses in recent years, because they allow consumers to make contactless purchases and payments with their smartphones and other devices. The NFC tags generally work by sending radio waves over a short distance. The recipient validates the information to complete the information exchange. The NFC tags have several benefits including having convenient and affordable features, providing instant connection, working through a wireless exchange and not requiring WiFi, 4G, 5G, or LTE connectivity.

In this example of the present invention, a connection between multiple persons who wish to join a social network and a business member of the social network is made using NFC tags. The business member has an establishment, and the connection is made by an information exchange between the individual persons (users) and business member using computing devices having Near Field Communication (NFC) tags, and each person is physically present at the establishment of the business member.

### Creating of User Profiles

After the above-described QR code and/or NFC tag steps are completed, the user who wishes to perform the specific tasks in the CG network computer application (App) of this invention logs into the application. The user may need to provide a password for further identifying themselves in the network and this further adds a layer of security to the system.

Next, the first user of the App looks at a first preference set containing a filter to identify the reasons for him/her connecting with a matching second user of the App at the specific location (e.g., establishment or venue). For example, this preference set may include the following filter or criteria to select from:
I am interested in meeting people for socializing (or);
I am interested in meeting people for dating (or);
I am interested in meeting people for networking (or);
I am interested in meeting people for hanging out (or);
I am interested in meeting people for friendship (or);
Other possible reasons for joining the social network can be included in the filter.

In addition, the preference set can include various other filters such as, for example, age ranges, physical features, gender, and the like of the user. The user also can include a photograph and short biography in his/her profile. For example, the biography section can include information on interests, geography preferences, schools, occupations, and the like.

After the first user completes the preference sets and profile, he/she will be matched with potential partners (the second users). In the system of the present invention, any potential partners (second users) must complete the same steps as the first user. That is, the second user also must scan the QR code, enter the secondary access code (if required), complete a profile, and the like. One key advantage of the system of the present invention is that the first and second users when using the App are physically located within the same establishment.

In the next step, the first user sends a request to chat with the potential partner (second user). If the first user's request is accepted by the second user, a chat box opens on their respective devices, so they are able to communicate on-line with each other. That is, the users have computing devices that can transmit and receive messages. Thus, the users are able to talk to each other in real time. Further, they can arrange a way of personally meeting each other in the establishment. If the users are a match for each other, they can decide to meet in-person in a safe, secure way inside of the establishment. The system of the present invention also allows the users to delete any messages from the chat boxes after connecting so that any exchanged messages remain private.

One advantage of the present invention is that the networking system is not based on geographic preferences or filters. Rather, all of the first and second users who are candidates for matching-up with each other are physically located in the same establishment. This helps provide a safe, secure environment for meeting and connecting with people of similar interests. As discussed above, the potential matching first and second users are identified by a filtering mechanism for introductions (e.g., who are they looking to meet and why are they looking.) Then, the potential matching users are identified by their respective profiles that they submitted. If both the first and second users are mutually interested, they are encouraged to meet in-person. That is, the users are encouraged to have inter-personal, real time contact. These real personal interactions are done within the confines of the establishment or venue.

Another advantage of the present invention is that the number of people at a given establishment will be provided. In one preferred embodiment, the number of people will be displayed on the graphical interface screen of the subscriber during the check-in step. However, the subscriber will not able to view other persons who are physically present at the establishment, unless the subscriber is also physically present at the establishment. This feature helps protect the privacy and safety of the subscribers. In one embodiment, the computing device of the subscriber will have their camera A pp disabled so that the subscriber cannot share photos and personal information to other people who are not physically present in the same establishment. As discussed above, the subscriber needs to enter through the virtual geofence before he/she can connect with other subscribers inside of the property's geofence. The subscribers who enter the geofence are eligible to send and receive messages from other subscribers on their computing devices. The present invention has many effective features for helping people to social interact more easily in shared physical places. Subscribers can use the system and methods of the present invention for meeting friends or new people having similar interests.

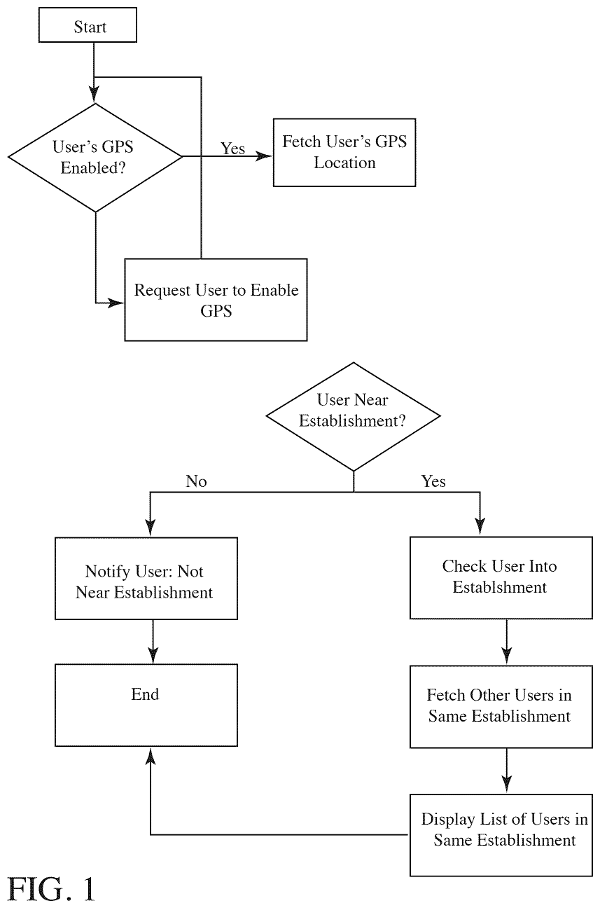

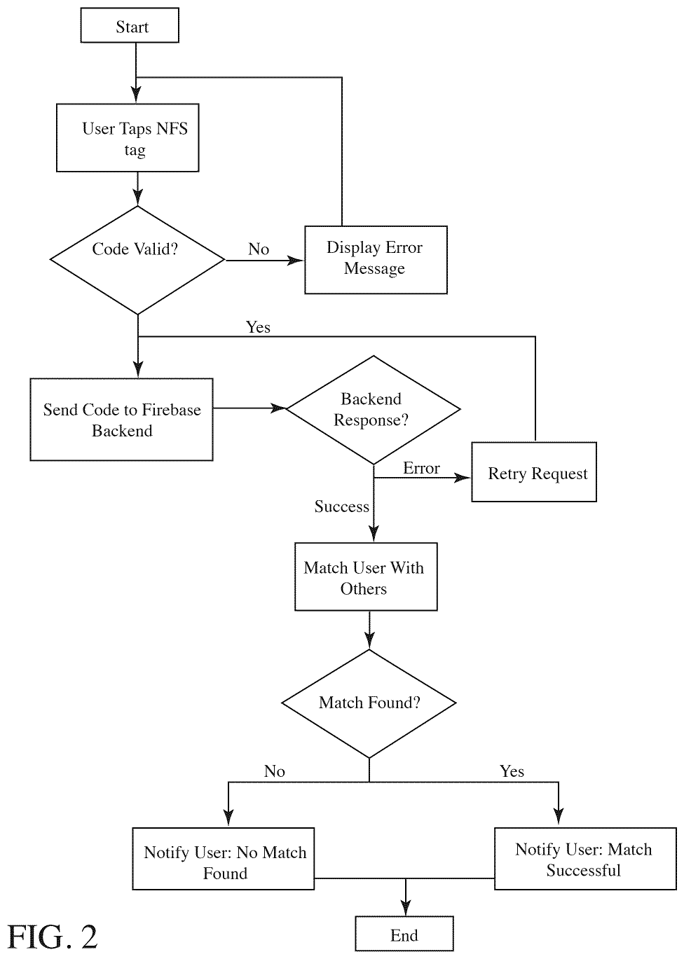

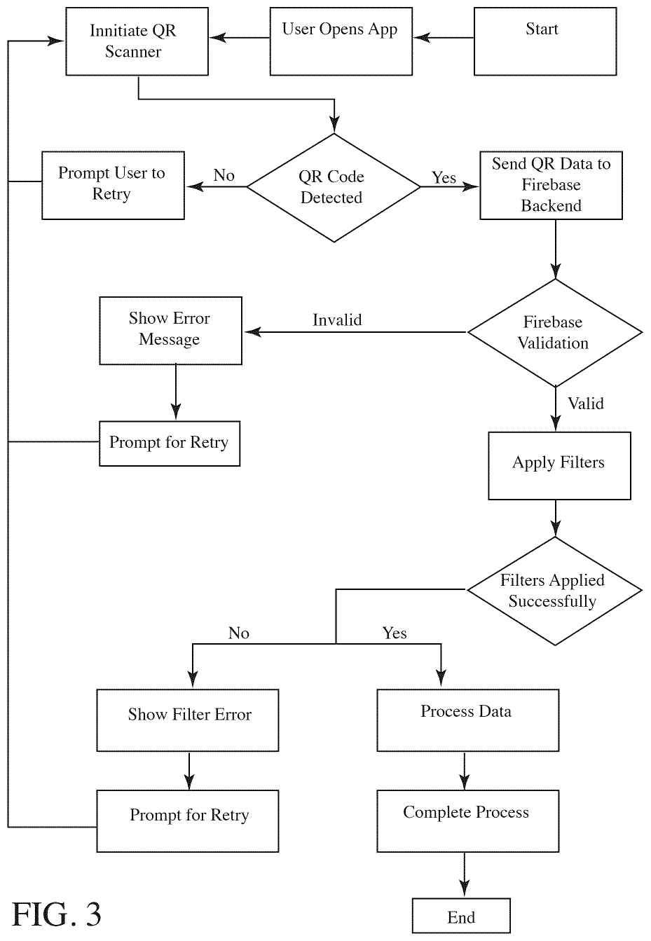

Referring to FIG. 1 and as discussed above, in one embodiment of the present invention, a user follows a Global Positioning System (GPS) signal to enter an establishment and connect with other users in the same establishment. In another embodiment, as shown in FIG. 2 and also discussed above, the user taps a NFC tag in an establishment and connects with other users in the same establishment. Turning to FIG. 3, in yet another embodiment, as further discussed above, the user scans a QR code in an establishment and connects with other users in the same establishment.

It should be understood that the systems, methods, and the like described and illustrated herein represent only some embodiments of the invention. It is appreciated by those skilled in the art that various changes and additions can be made to the systems, methods, and the like without departing from the spirit and scope of this invention. It is intended that all such embodiments be covered by the appended claims.

I claim:

1. A method for socially connecting persons, comprising the steps of:
creating a Quick Response (QR) code for a business member of a social network, wherein the business member has an establishment, the network having multiple business members, wherein each business member in the network has a different QR code than another business member;
receiving a request from multiple persons who wish to join the social network, wherein each person scans the QR code for the same business member in the network and each person is physically present at the same establishment of the business member;
identifying a first user of the network based on the user creating a first preference set and a first profile on a computing device;
identifying at least a second user of the network based on the second user creating a second preference set and a second profile on a computing device;
matching the first user and second user based on the first and second user profiles and allowing the first and second users to chat with each other on their computing devices so that the first user can meet the second user in-person at the establishment if such a meeting is mutually-agreeable.

2. The method of claim 1, wherein the first and second preference sets include a reason for meeting people as either socializing or dating or networking or hanging out or friendship.

3. The method of claim 1, wherein the first and second preference sets includes age ranges, physical features, and genders.

4. The method of claim 1, wherein the first and second profiles include photographs and biographies of the first and second users.

5. The method of claim 1, wherein the computing device is selected from the group consisting of mobile phones, personal computers, laptops, and hand-held tablets.

6. A method for socially connecting persons, comprising the steps of:
creating a connection between multiple persons who wish to join a social network and a business member of the social network, wherein the business member has an establishment, the connection being made by an information exchange between the persons and business member using computing devices having Near Field Communication (NFC) tags, and each person is physically present at the establishment of the business member;
identifying a first user of the network based on the user creating a first preference set and a first profile on a computing device;
identifying at least a second user of the network based on the second user creating a second preference set and a second profile on a computing device;
matching the first user and second user based on the first and second user profiles and allowing the first and second users to chat with each other on their computing devices so that the first user can meet the second user in-person at the establishment if such a meeting is mutually-agreeable.

7. A method for creating a location-based connection between subscribers on a social network, comprising the steps of:
creating a first geofence around a location of a first subscriber and communicating a first group of establishments of interest inside of the geofence to the first subscriber on a first computing device, wherein the first subscriber selects a specific establishment;
creating a second geofence around a location of a second subscriber and communicating a second group of establishments of interest inside of the geofence to the second subscriber on a second computing device, wherein the second subscriber selects a specific establishment;
wherein the first and second subscribers select the same specific establishment inside of the geofence;
creating a third geofence around the specific establishment selected by the first and second subscribers on their computing devices;
wherein the first and second subscribers enter the third geofence;
receiving requests from the first and second subscriber to connect with each other on the social network, the first and second subscribers being virtually present in the third geofence and physically present in the selected establishment;
identifying the first subscriber of the network based on the first subscriber creating a first preference set and a first profile on the first computing device;
identifying the second subscriber of the network based on the second subscriber creating a second preference set and a second profile on the second computing device;
matching the first subscriber and second subscriber based on the first and second subscriber profiles and allowing the first and second subscribers to chat with each other on their computing devices so that the first subscriber can meet the second subscriber in-person at the establishment if such a meeting is mutually-agreeable.

8. The method of claim 7, wherein the first and second geofences are circular each having a specific radius.

9. The method of claim 7, wherein the computing device is selected from the group consisting of mobile phones, personal computers, laptops, and hand-held tablets.

10. The method of claim 7, wherein the first and second preference sets include a reason for meeting people as either socializing or dating or networking or hanging out or friendship.

11. The method of claim 7, wherein the first and second preference sets includes age ranges, physical features, and genders.

12. The method of claim 7, wherein the first and second profiles include photographs and biographies of the first and second users.
